(19) United States
(12) Patent Application Publication
(10) Pub. No.: US 2006/0019211 A1
(43) Pub. Date: Jan. 26, 2006

(54) Bracket having .017" x .024" arch slot, wire system and tube system

(76) Inventors: Robert M. Ricketts, Scottsdale, AZ (US); Robbin Machette, Piedmount, CA (US)

Correspondence Address: SHERIDAN ROSS PC, 1560 BROADWAY, SUITE 1200, DENVER, CO, 80202, US

(21) Appl. No.: 10/892,895

(22) Filed: Jul. 16, 2004

Related U.S. Application Data
(63) Continuation of application No. 10/821,699, filed on Apr. 9, 2004.
(60) Provisional application No. 60/462,085, filed on Apr. 11, 2003.

(51) Int. Cl. A61C 3/00

(52) U.S. Cl. 433/8

(57) ABSTRACT

The present invention is directed to orthodontic brackets having wire slots therein that are less than about 0.0175 inches in width, and greater than about 0.0165 inches, and more preferably about 0.017 inches. Additionally, the slots of the brackets of the invention can have a shallower depth than prior art slots, and in particular, a depth of approximately 0.024 inches. Thus, in one embodiment, a bracket having a slot of 0.017″×0.024″ (0.43 mm×0.60 mm) is provided, wherein this new bracket is particularly useful for reorienting second molars. Moreover, the brackets of the present invention are in keeping with clinical requirements for anchorage and the need for overtreatment. In addition, the present invention meets the needs for placing teeth in positions to protect against the forces that cause malocclusion in order to best prevent relapse. Furthermore, the present invention provides the requirements for application of appropriate forces, particularly dental expansion.

### PRIORITY CLAIMED TO RELATED APPLICATIONS

The present application is a continuation of prior pending U.S. patent application Ser. No. 10/821,699 filed Apr. 9, 2004, which claims the benefit of U.S. Provisional Patent Application No. 60/462,085 filed Apr. 11, 2003. The entire disclosures of the prior applications are considered to be part of the disclosure of the present application and are hereby incorporated by reference.

### BACKGROUND

Pin and Tube Evolved to Ribbon

Dr. E. H. Angle developed a fixed 0.045″ (1.14 mm) Expansion Arch having threaded ends and activated with nuts. The teeth were ligated to the wire and rubber blocks were employed for more continuous action. The teeth were tipped outward, uncontrolled (FIGS. 1A and 1B).

In order to “grow bone,” Dr. Angle devised a method to move the roots. “Spurs” were soldered vertically on a smaller round wire. The evolution of the edgewise mechanism started with a pin and tube scheme as one skilled in the art will understand. Vertical 0.022″ diameter wires (0.56 mm) were soldered on a 0.030″ (0.76 mm) arch wire. These vertical wires (known as “pins,” cut for proper length, were engaged in vertical 0.030″ tubes soldered onto the bands. FIGS. 2A-2C shows this technique. Due to quite delicate needs with adjustments, that system was discontinued.

Historically, the next change was the conversion of the tube to a bracket. The round tube was flattened and a ½ length slice was cut with a disc. The cut was squared at the corners and made to receive a rectangular flat wire. A round wire of 0.76 mm diameter was rolled into a wire of 0.022″×0.036″ cross sectional dimension (0.56 mm×0.91 mm) and hence called a “ribbon.” It was fixed into a “ribbon bracket” by means of a pin bent over the bracket. FIGS. 3A-3C show the components that resulted from the use of brackets and how these components appear when in use.

Tiny Ribbon

Due to the difficulty of controlling angulations, and further, the rigidity and bulk of the wire with threaded ends and nuts for adjustments, a “tiny ribbon” was developed in 1924. This appliance was intended for deciduous and mixed dentition treatment. The threaded wire was discontinued and the wire was reduced to 0.022″×0.026″ cross sectional dimension (0.56 mm×0.66 mm).

Primary Edgewise

Dr. Angle then designed a bracket for horizontal entry of the wire (the components of which are shown in FIGS. 4A and 4B) rather than the previous vertical entry Turning the rectangular wire ninety degrees, i.e., turning it so that the narrow side is substantially in line with the plane of the patient's face (i.e., on its “edge”), use of the wire in this orientation came to be labeled as the “primary edgewise” technique (see FIG. 5) The primary edgewise technique was patented circa 1928 at about the same time that Atkinson patented what is known in the art as the “Universal bracket”. The selected wire by Angle had dimensions of 0.022″×0.028″ wire which was ligated into (i.e., tied onto) the bracket. For example, FIG. 6 shows the method used for tying a steel ligature wire to a bracket.

Also, about the time of the introduction of the primary edgewise technique, the notion of the three-order movement (equivalently, three planes of control) was publicized, wherein height and angulation were adjusted by band placement (further description of the order of movements is provided in the Terms and Definitions section hereinbelow under “Three dimensional principal”). The torque for controlling tooth movement was bent into the wire (an illustration of the use of three order control is shown in FIG. 7, wherein forces may be induced upon a tooth to thereby induce five different tooth movements). In and out bends were employed to manage the differences in the sizes of the various teeth. Rotations were still difficult; consequently, the addition of a staple was employed for the ligature tying of rotations. The staple was ineffective due to a short lever distance and a strong wire resistance in the horizontal plane.

Error in Concept with Primary Edgewise

While the components of primary edgewise seemed simple, in retrospect, a biological assumption was made which is in error. The assumption was that expansion required heavier forces than movements within the line of arch. That is, the alveolar cortical plates, being compact bones, were believed to require greater force for alteration. Accordingly, forces applied were in fact gauged by pain tolerance. The use of ligature tying pliers were taught adamantly. Consequently, this assumption lead to the thicker dimension of 0.028″ of the rectangular wire, 0.022″×0.028,″ in the contralinear direction (see the Terms and Definitions section for a definition of this term). Thus, the rectangular wire produced greater force horizontally than vertically. See FIG. 8d for an example of such a wire 802.

History proved, however, that the primary edgewise method, designed for expansion, was essentially unsuccessful as it came to be employed by the mainstream of clinicians. Both hard and soft tissue was lost. Findings gave rise to the concept of treating to the “apical base” or keeping teeth “on the ridge.” Extraction rates rose to as much as 90% in some practices.

Secondary Edgewise

Another development was the so called “secondary edgewise” technique. The secondary edgewise technique was developed soon after the primary edgewise was invented. Round 0.016″ wires for leveling and alignment were employed in the secondary edgewise technique for attaching to an orthodontic bracket. In particular, such brackets had the same slots of dimensions. Although this smaller wire was used, the pressure (force per unit area) was increased due to the contact of the crest of the alveolus. Due to the tipping and flaring of lower incisors in particular, a routine “tie back” off simple helix loops was a part of the regimen. This “milked” the lower arch forward and rotated molars mesially when they were already 10 to 30 degrees rotated forward.

In addition, possibly due to sclerotic changes in the anterior periodontium arising from the secondary edgewise technique, the premolars were extruded; i.e., in FIG. 9 the premolars would be extruded. Moreover, this technique had as a consequence that the mandible was undesirably rotated open. Additionally, during treatment of Class II malocclusion, during the early stages, the maxillo-mandibular relation worsened. Moreover, as Class II elastics were applied, the dentition of some patients rotated even more, while in others, the upper molars were intruded due to extrusion of the lower posterior teeth. The extrusion often occurred if tipping of the lower molars buccally occurred in the first stages of treatment. By 1950 extra oral traction had been added in various forms.

Tertiary Edgewise

A third general orthodontic scheme was one led by Dr. Charles Tweed. It consisted of even heavier forces and the use of 0.0215″×0.025″ steel wire in the 0.022″ brackets. Extraction rates elevated, and a variety of methods for closing space were conducted. Tip back second order bends were activated in the lower teeth by Class III elastics from the upper teeth. This step was followed by Class II elastics. However, extra-oral traction came to be employed throughout treatment from hooks off the full upper arch. Very heavy torque was advocated for the upper incisor segment.

Quaternary Edgewise—Bioprogressive

The fourth movement was an evolution due to information gained from several sources.

A quaternary edgewise—bioprogressive technique was developed, wherein lighter and more continuous actions over longer time intervals were found to be advantageous. Moreover, several related developments occurred in a relatively short period of time. First was the bypassing of certain teeth that were used with other previous orthodontic techniques. Second, two parallel brackets were aligned on a band 1004 having brackets 1008 as shown in FIG. 10A. Third, winged brackets 1010 and 1012 were designed as shown in FIG. 10A. Fourth, was the introduction of simple loops as one skilled in the art will understand. A gold 0.021″×0.021″ wire became the standard working wire. FIG. 13C shows a pair of such wires used with parallel brackets.

A fifth development, was the elimination of staples altogether (e.g., staple 804 FIG. 8d) for assisting in maintaining an alignment of the arch wire.

The use of two brackets milled together was trademarked “Siamese” by Rocky Mountain Orthodontics (RMO), the assignee of the present application. Siamese brackets were cast by 1980. The “twin design” dominated clinical use for a time.

However, two brackets on each tooth reduced the working space between teeth. This shortened the lever distance proximally as also shown in FIG. 10B. The change to Siamese brackets came at a point in time when lighter forces and more continuous action was desired. However, such lighter forces posed a dilemma in that there was a need for a smaller slot size to better secure the wire and maintain appropriate control over the forces applied to teeth.

The 0.018″ Slot

Accordingly, a bracket slot size of 0.018 inches was developed by Dr. Ricketts and RMO as an answer to the need for a smaller slot size in order to maintain a three-plane control. Embodiments of a 0.018″ slot are shown in FIGS. 11A-11G. In an additional development, a 0.016″×0.016″ Elgiloy Blue wire was found to have a 2000 gram-mm moment which was sufficient for movement of molars and therefore any tooth. FIGS. 12A- 12H shows both the force characteristics of the Elgiloy Blue wire and some of the configurations of this wire for various orthodontic techniques. For auxiliary use and greater access, originally the 0.018″ slot had a depth of 0.030″.

Preformed Bands and Preadjusted Brackets and Tubes

Pinching of bands was labor intensive, time consuming and first required interproximal space creation as one skilled in the art will understand. With advances in the technology of base metals, refined thinner bands were progressively applied, and essentially eliminated separation for interproximal space creation.

Work in the details of occlusion, anchorage and relapse tendencies produced angulation specifications, which were standardized in orthodontic practice. Appropriate torques on the upper incisors were determined for the most common problems. Occlusal plane management together with anchorage control entered into the controversies of bracket formulation. Teeth were arranged in positions to resist relapse. Certain of the old arch forms and tooth positions were found to be unacceptable. As a result of intensive study, the traditional teaching of orthodontic techniques was changed.

The Art of Wire Crimping for Minor Adjustments

Any major movements of teeth require loops (e.g., FIG. 12C) for the most efficient three-plane control and anchorage management. For minor movements, e.g., one millimeter or less, an arch wire can be manipulated while in the mouth. The 0.016″×0.016″ (equivalently, 0.41 mm×0.41 mm) Elgiloy Blue wire was, after years of experimentation, found to be the most excellent in quality. This was due to its malleability and protective superiority.

Pressure Concepts and Rating Scales

In addition, findings from laboratory experiments and clinical trials led to the “pressure” technique of one gram per square mm of engaging bone surface. Further, it was known, but not applied, that new alveolar bone was developed by the periosteum on the outside that was stimulated best by pressures of 0.5 gram per mm² or even less (in the 0.3 to 0.4 gram range).

Still another change was the development of plastic tie rings and chains. Also, elastic threads became available.

Finally, it was found that intrusion of teeth was possible and ironically, perhaps, such intrusion was the easiest of all movements when forces were directed by the proper amount of pressure, in the most appropriate direction and in a continuous manner.

While centers of rotation were sought, teeth were only temporarily subject to restraints from periodontal ligaments. The ligament stretched under continuous action. After eight minutes of tension on the ligament, the tooth was against the socket on the pressure side. Anchorage in fact came from the bone, not the ligament on the tension side. The first anchorage consideration was the amount of pressure leading to a sclerotic stabilization. The second was the type of bone contacted, hence, the concept of directional force. Cortical anchorage or cortical avoidance became the central clinical issue.

As a result of continued research, the mean sizing of roots was calculated and root rating scales were offered to the profession as a starting reference. Differential pressures thus could be sensibly applied.

Parallel Developments

Several conversions occurred in the orthodontics profession almost simultaneously circa the 1970s. FIG. 15 shows six areas where there were developments during this time period.

Quite fundamental were the improvements in bonding (1 in FIG. 15) and its consequences. The bonded attachment was less stable and would become detached with the typical forces employed. Therefore, a clinician was forced into lighter and lighter forces (2 in FIG. 15) lest brackets snap loose.

Then the third development occurred. Under the idea of conserved band space, credit was given to a shift to less extraction and more expansion. Probably, however, the successes that occurred were due to the lighter expansion forces, which led to better alveolar development.

Regarding the concepts of therapeutic occlusion (3 in FIG. 15), germination for change was motivated by the “therapeutic ideal” alignment with the placement of canines and lateral incisors, rotations of molars, torque on upper incisors and appropriate arch forms as shown in FIG. 13.

With more precise specifications of the bracket and tube, the details for the individual tooth morphology, the occlusal functions and anchorage needs were addressed. This gave rise to several formulations in orthodontics, which were often guided by preference rather than science. This was abetted by the advent of metal injection molding technology by manufacturers (i.e., the injection process in manufacture, 4 in FIG. 15). Prescription brackets had a hey-day and time of vigor.

Another parallel development was the discovery of a curve of growth for prediction of the mandible (i.e., the forecasting to maturity, 6 in FIG. 15). The spin-off from this was that for the first time, within reason, long range forecasting and treatment to the adult face became feasible.

Another subtle factor toward change was that of a shift from the recessed mouth to a fuller smile and fuller dental profile on an esthetic basis (i.e., the cultural concepts in esthetics, 5 in FIG. 15). Thus the standards of objectives were modified.

All these factors were entwined in an alteration toward smaller brackets, lighter dental forces but continued orthopedic forces on the maxillary and the ubiquitous shift toward earlier intervention and nonextraction.

The above description outlines the evolution of fixed brackets and tube designs. Shockingly there was a dearth of applied science. The original 0.022″ (0.56 mm) slot (circa 1916) was perhaps the width of a cut with a “Joe Dandy” disk. Custom or habit was then followed to substantially the present day.

Clinical and laboratory studies on pressure values, however, have led to a whole series of reductions in wire composition and temper.

The bracket forms, the techniques of bracket manufacture, direct bonding, and the means of ligation all changed. The attempt to lighten forces and reduce wire size while maintaining three-plane control led to a 0.018″ (0.46 mm) slot in 1958 and was the basis for further reform.

Due to further scientific evidence that even lighter orthodontic forces on teeth are preferable, there remains a need to be able to more accurately direct and induce such lighter forces via thinner wires, e.g., the 0.016″×0.016″ (or 0.41 mm×0.41 mm) wire in Elgiloy Blue (or thinner). Accordingly, it is desirable to have brackets with slots that can more effectively accommodate such thin wires, wherein the slots are smaller than those described thereinabove.

Terms and Definitions:

Bioprogressive technique: A progression of steps toward an intended goal carried out under biologic principles.

Clinical requirements for anchorage: An anchorage that is resistive to a drag and has several sources.

Contralinear direction: At an orientation that is substantially perpendicular to the plane defined by the arch wire.

Facile formula: A formula for providing easier and/or more efficient tooth movement, wherein smaller forces are induced on the tooth. More specifically, the facile Formula refers to a prescription (technique), developed by the inventor, that includes dimensions for brackets for 20 teeth. There may also be a prescription for a tube as well, wherein the prescription identifies the dimensions of a bracket which includes: slot size, torque, angulation, offset, in/out, and possibly width, height, and depth.

For the contralinear direction, the Facile formula permits use of, e.g., a 0.012″×0.0165″ wire or a 0.012″×0.017″ wire placed ribbon wise in order to reduce traumatic forces, and the use of a corresponding bracket slot of 0.017″×0.024″.

Another feature of the facile formula pertains to the upper and lower second molars. Research from significant numbers of patients has shown that clinicians traditionally place the second molars in line with the buccal section of the premolars and first molars. According to present studies this means that they either over widen the second molars or contract the first molars. Experimental data has shown that the second molars in normal occlusions are located inside the buccal line an average of almost 2.0 mm in both arches (i.e., 2.08+−1.02 mm lower and 1.9+−1.03 mm upper).

In addition, the old tradition is to place the second molars in a flat plane with the first molar. This takes out the normal curve of Spee.

Consequently, the tube for 6 degree rotation, 34 degree torque was raised on the buccal 1.0 mm (from the standard 0.7 mm mesial spot) and was moved downward on the lower 2.0 mm and occlusalward on the upper 2.0 mm. This is in conformity with normal development. The remaining 1.0 mm inset of the second molars can be handled with a “survey” of the finger to curve the arch wire posteriorly.

Finishing: A step in a complete regime which entails details.

Overtreatment: All tissues stretch and then shrink. Overtreatment is a process for taking into account the shrinkage.

Ribbon wise: A process of orthondontically applying an arch wire applied to a patient's teeth, wherein the arch wire is thicker in directions from the patient's gums to the teeth biting edges (generally known as the “vertical” direction) than in the directions that traverse a plurality of teeth between the patient's gums and the teeth biting edges (generally known as the “horizontal” direction).

Bracket profile (e.g., thickness): The bracket dimension that is the distance that a bracket extends away from the surface of tooth to which the bracket is attached.

Thread ligation: An elastic thread (rather than a soft metal wire) for use in orthodontically correcting a patient's dentition.

Three dimensional principle (three order control, or three order movement, or three planes of control): These terms are used herein synonymously for describing the movement directions of teeth. Note, in FIG. 7 the three planes are vertical (#1 height, FIG. 7), horizontal (#2 angulation, FIG. 7), and transverse (#4 torque, FIG. 7), in addition to rotation (#3 rotation, FIG. 7).

### OBJECTS OF THE INVENTION

Since current scientific orthodontic research indicates that when continuous, very low force (e.g., forces in the range of 0.3 to 1.0 grams per millimeter (mm) of root surface) are applied to a patient's dentition, a reorientation of the patient's teeth occurs faster, safer, and with far less discomfort, arch wires that can reliably and continuously produce such low orthodontic forces are very desirable. However, such low force arch wires (e.g., 0.016″×0.016″ Elgiloy Blue wire) are, by orthodontic standards, much thinner than arch wires that produce larger orthodontic forces. Accordingly, when used with brackets having slots of, e.g., 0.018″ or greater in width, the following problems are encountered:
(a) the thin arch wires become unfixed with the brackets;
(b) the thin arch wires may not align along a patient's dentition as an orthodontist intends due to the relatively large examine space (in orthodontic terms) between the bracket slot sides and such a thin arch wire; accordingly, the desired dentition correcting forces may not be as precise as desired. This may result in extra orthodontic sessions by the patient to adjust the arch wire.

Accordingly, due to all of the above identified problems using orthodontic brackets having slots of a width greater than 0.0175 inches with the most orthodontically correct arch wires (i.e., thin arch wires), it is an object of the present invention to provide brackets with slot widths of less than 0.0175 inches, and more preferably less than or equal to 0.017 inches.

Furthermore, since the smaller the distance that a bracket extends away from the surface of its attached tooth (i.e., a bracket whose thickness is reduced), the less irritation of the soft tissue contacting the bracket, it is also an object of the present invention to provide novel brackets with slots that have a reduced depth, thereby allowing such brackets to have reduced thicknesses in comparison to prior art brackets. In particular, by reducing bracket slot depth to a range of approximately 0.026 inches to 0.022 inches, and more preferably about 0.024 inches, it is also an object of the present invention to reduce the thickness of the brackets to less than approximately 0.055 inches, and more preferably less than approximately 0.048 inches.

Additional objects of the present invention are recited hereinbelow.

### SUMMARY

The present invention is directed to orthodontic brackets having wire slots therein that are less than about 0.0175 inches in width, and at least in some embodiments, greater than about 0.0165 inches. More preferably, the present invention is directed to orthodontic brackets having a slot width of about 0.017 inches.

Moreover, for the contralinear direction, the present invention is particularly useful in the context of new orthodontic techniques that utilize much lighter forces since the present invention will permit use of a 0.012″×0.0165″ wire placed ribbon wise in order to reduce traumatic forces. This is a significant change from the prior art in that the wire dimension is reduced from 0.028″ to 0.012″ in the contralinear direction.

Additionally, it is an aspect of the present invention that the slots of the brackets of the invention can have a shallower depth than prior art slots, and in particular, a depth in the range of approximately 0.026 inches to 0.022 inches, and more preferably about 0.024 inches. Thus, in one embodiment, a bracket having a slot of approximately 0.017″×0.024″ (0.43 mm×0.60 mm) is provided, wherein this new bracket, and additionally a corresponding reduced size tube, is particularly useful for reorienting second molars from errors conducted with most previous orthodontic techniques as, e.g., recited in the Background section hereinabove.

Moreover, the brackets of the present invention are in keeping with clinical requirements for anchorage and the need for overtreatment as described in the Terms and Definitions section hereinabove.

In addition, the present invention facilitates placing teeth in positions to protect against the forces that cause malocclusion in order to best prevent relapse. Furthermore, the present invention facilitates the application of appropriate forces, particularly dental expansion in that the brackets of the present invention can be of reduced thickness.

In one embodiment, canine brackets according to the present invention are rounded at the slot floor. A bracket according to the present invention may be also raised and torqued according to the scientific data reported in: Robert M. Ricketts, 1989, Provocations and Perceptions in Cranio-Facial Orthopedics (published by RMO, Inc., Denver, Colo., USA, pp. 982-1021) incorporated herein fully by reference, wherein a raised and torqued bracket is understood to be a bracket that that will offer control in three dimensions. Note that the research studies in the immediately above cited Rickett's report were made with the orthodontic appliances placed directly on teeth of skulls, ibid., pp. 669-747. The values for torque attracted the most controversy (e.g., the angular values of FIG. 17). The findings of these studies were not just theory, but were proven clinically in patients studied years after treatment.

In one embodiment of the present invention, angulations greater than three degrees may be built into the bracket and tube position. However, such minor angulations need not be provided during manufacturing in that they can be provided at the time of an orthodontic treatment session. Note that such angulations are critical for the following teeth: upper lateral, upper canine, lower 1^{st} molar, and lower 2^{nd} molar.

The novel brackets of the present invention were developed in response to the following scientific and experiential findings:
1. The three dimensional principle (i.e., three order control) remains valid. Thus, the bracket of the present invention provides better three dimensional management when moving a patient's teeth.
2. The 0.016″×0.016″ (or 0.41 mm×0.41 mm) wire in Blue Elgiloy has proven to be biologically sound for orthodontic needs.
3. For finishing, some orthodontists have complained of excessive slot space with the 0.016″×0.016″ wire in brackets having a 0.018″ slot. As a consequence, these clinicians have recommended larger wires to thereby reduce this slot space.
4. A 0.017″ slot permits use of a 0.015″×0.015″ wire for ordinary alignment maintaining three-dimensional control. For finishing, the 0.016″×0.016″ wire is still appropriate, but now with greater precision.
5. Highly resilient wires used in the 0.018″ slot bracket can still be employed in slots according to the present invention.
6. The 0.030″ bracket depth was originally designed for ease of steel ligature placement before the advent of polymer ligature rings. The deeper slot was also used for the purchase of an overlay round wire for buccal rotations and alignment. With thread ligation employed for canine intrusion, such “piggy-backing” of is no longer necessary. Moreover, in the prior art, after alignment of a patient's teeth when large movements are necessary, a straight continuous wire was used unless severe rotations and angulations or further expansion was required. Moreover, when such severe rotations and angulations or further expansion was required, a “T” loop series was used (FIG. 14H shows such a series of “T” loops). However, by using , the lighter, flatter, wire with the brackets of the present invention, the use of “T” loops can be reduced.
7. With the common usage of straight wire, the second molar was placed in an improper position in three dimensions. The first error was that of height. In particular, the Curve of Spee was not built into the treatment, as one skilled in the art will understand. FIG. 17 shows the values of torque for the lower 1^{st} molar and lower 2^{nd} molar to be, −24° and −34°, respectively. The second error was in attempting correction by requiring an offset in the height of the tubes, wherein the lower tube is placed more gingivally and the upper tube is placed more occlusally. The third error was that of horizontal crown position relative to the buccal line. In particular, the second molar tube was raised in order to provide a buccal curve not employed in standard arch forms. Accordingly, such improper three dimensional positioning necessitated the need for a new tube such as provided by the present invention.
8. A flatter profiled bracket produces less lip irritation, is less obtrusive to esthetics, and places the wire closer to the face of the tooth for control enhancement. Accordingly, brackets of the present invention have flatter profiles.

It is also an aspect of the bracket of the present invention that it will accept all the previous wires or modular sections employed with 0.018″ slots.

Further advantages and benefits of the present invention will become evident from the Detailed Description hereinbelow and the accompanying figures.

### BRIEF DESCRIPTION OF THE DRAWINGS

FIGS. 1A and 1B show a prior art orthodontic technique using a fixed 0.045″ (1.14 mm) Expansion Arch having threaded ends and activated with nuts.

FIGS. 2A, 2B and 2C show a prior art orthodontic technique using vertical 0.022″ wires (0.56 mm) that were soldered on a 0.030″ (0.76 mm) arch wire.

FIGS. 3A, 3B and 3C show a prior art orthodontic technique using a bracket instead of a vertical tube.

FIGS. 4A and 4B show the components used in a prior art design for a bracket wherein there is horizontal entry of the wire.

FIG. 5 shows an orthodontic wire having a rectangular cross section, wherein in an operable position, the narrow side of the wire is substantially parallel with the surface of the teeth. The wire has dimensions of 0.022″×0.028″.

FIG. 6 shows the method used for tying a steel ligature wire to a bracket.

FIG. 7 shows an illustration of three order control, wherein forces may be induced upon a tooth to thereby induce five different tooth movements. Further details are provided in the Terms and Definitions section hereinbelow under “Three dimensional principal”.

FIG. 8 shows the components of prior art for the primary edgewise appliance as follows: (i) 8a, a band; (ii) 8b, a bracket; (iii) 8c, a tube; (iv) 8d, a staple 804; (v) 8e, a wire.

FIG. 9 shows changes in the anterior periodontium from the use of the prior art “secondary edgewise” technique, wherein the premolars were extruded.

FIGS. 10A and 10B shows three embodiments of brackets (FIG. 10A), and an operative embodiment of their use (FIG. 10B) with a 0.021″×0.021″ gold wire.

FIGS. 11A-11G shows embodiments of brackets having a 0.018 inch wire slot.

FIGS. 12A-12H shows both the force characteristics of the Elgiloy blue wire and some of the configurations of this wire for various orthodontic techniques.

FIG. 13 shows the positioning of an arch wire and direction of tooth movement for the following: (i) 13A, the primary edgewise technique; (ii) 13B, dentition alteration using steps from the bioprogressive technique, upper arch (the Terms and Definitions section provides a description of the bioprogressive technique); (iii) 13C, the bioprogressive technique, lower arch.

FIGS. 14A through 14M show, among other features, various wire configurations and embodiments of a plier (FIGS. 14D and 14E) for use with a bioprogressive technique.

FIG. 15 shows six areas where there were developments during the 1970s.

FIG. 16 is a side view of a bracket (1600) having a 0.017″×0.024″ (0.43 mm by 0.61 mm) slot (1604) according to the present invention showing that a wire having a cross section of 0.016″×0.016″ (0.41 mm by 0.41 mm) can be readily inserted into the slot 1604.

FIG. 17 shows the orthodontic torques required as a standard.

FIGS. 18A through 18C show, respectively, top, side and cross section views of a bracket according to the present invention for a maxillary cuspid/bicuspid.

FIGS. 19 through 28 show a side view of various embodiments of a according to the present invention having a slot of approximately 0.017 inches in width and approximately 0.024 inches in depth.

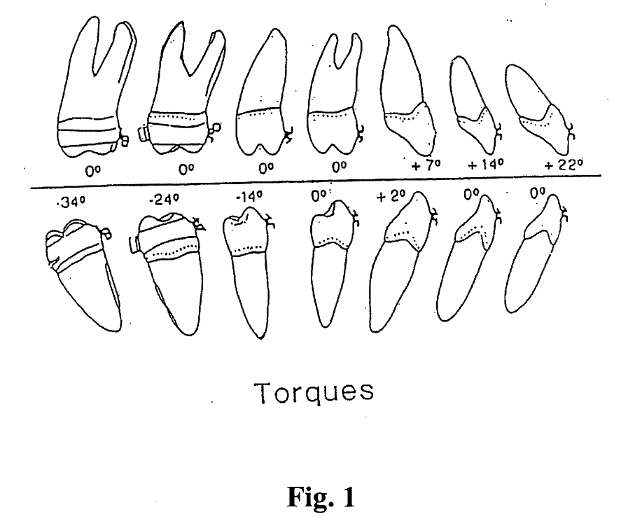

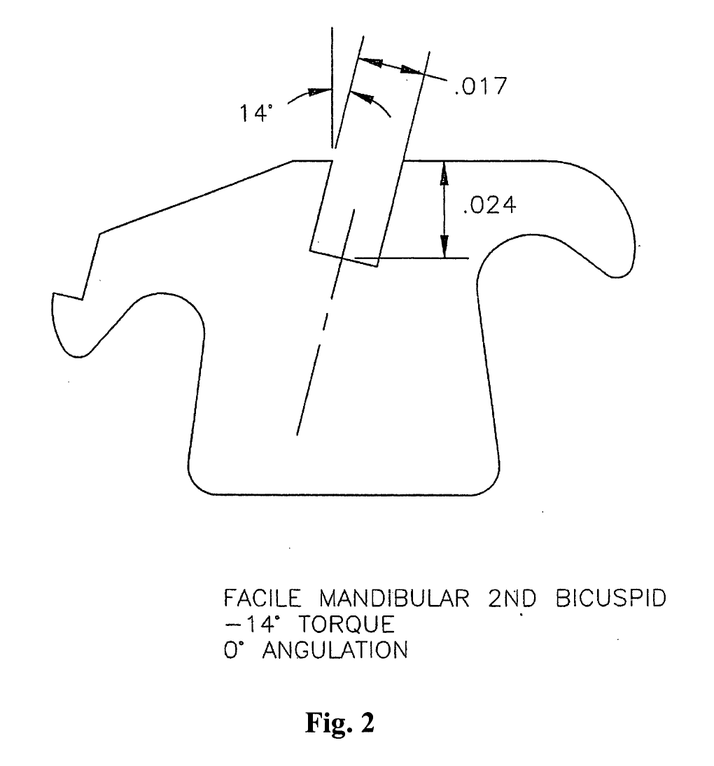

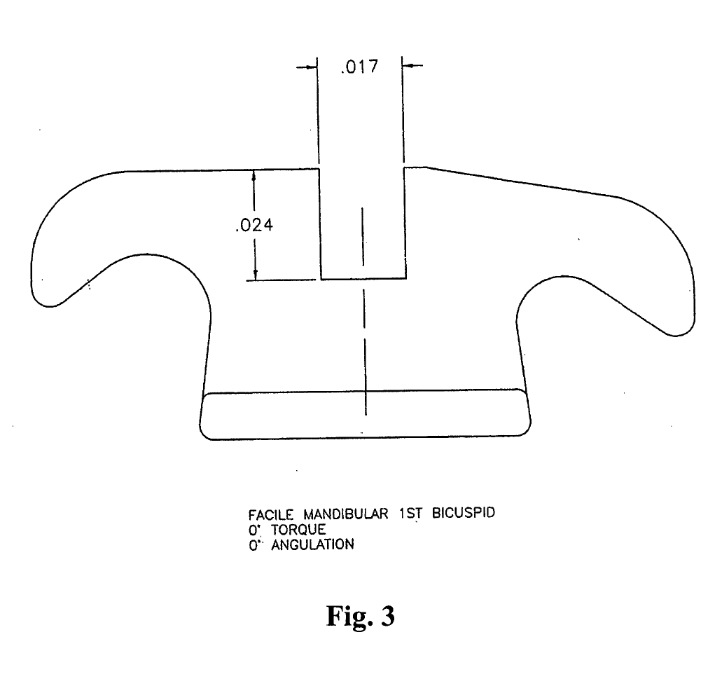

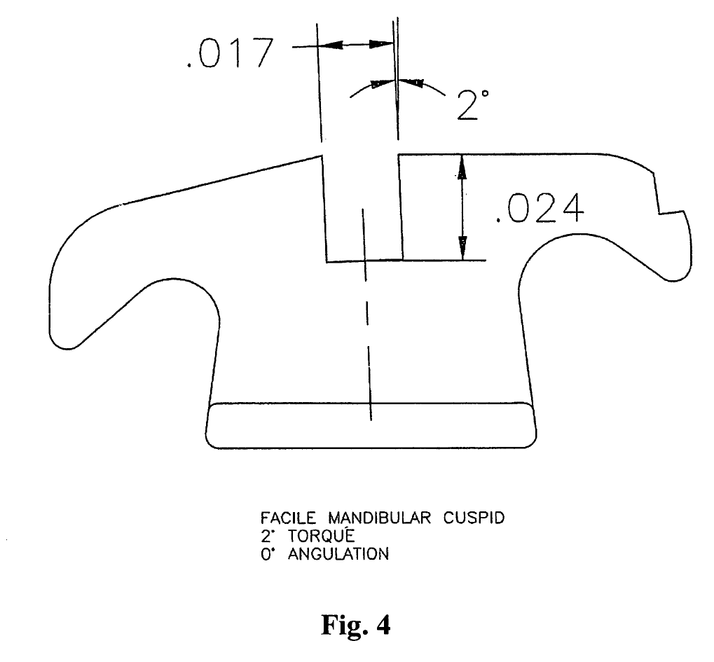

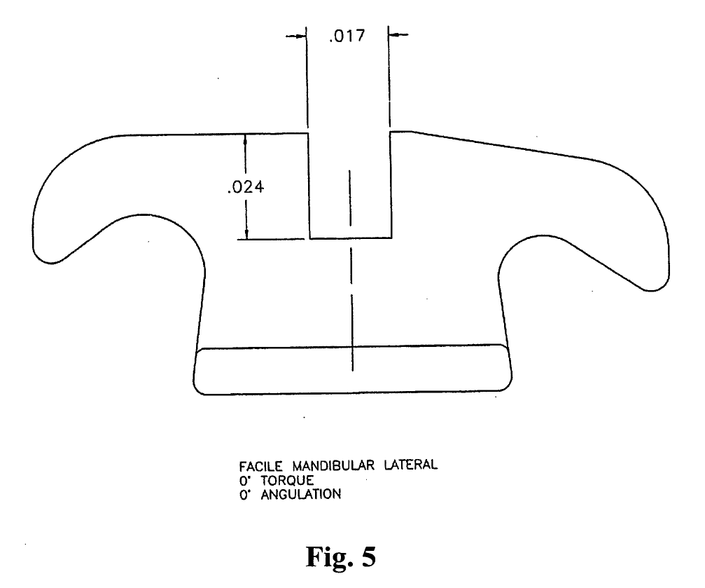

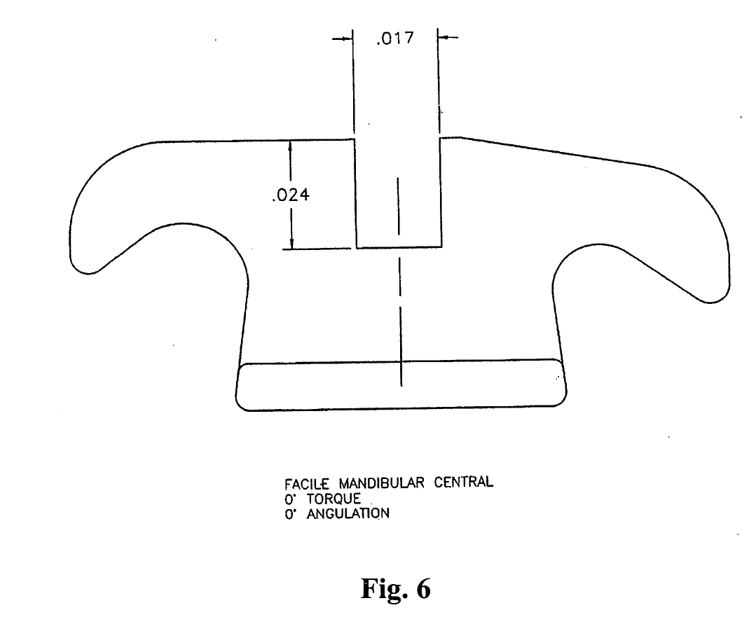

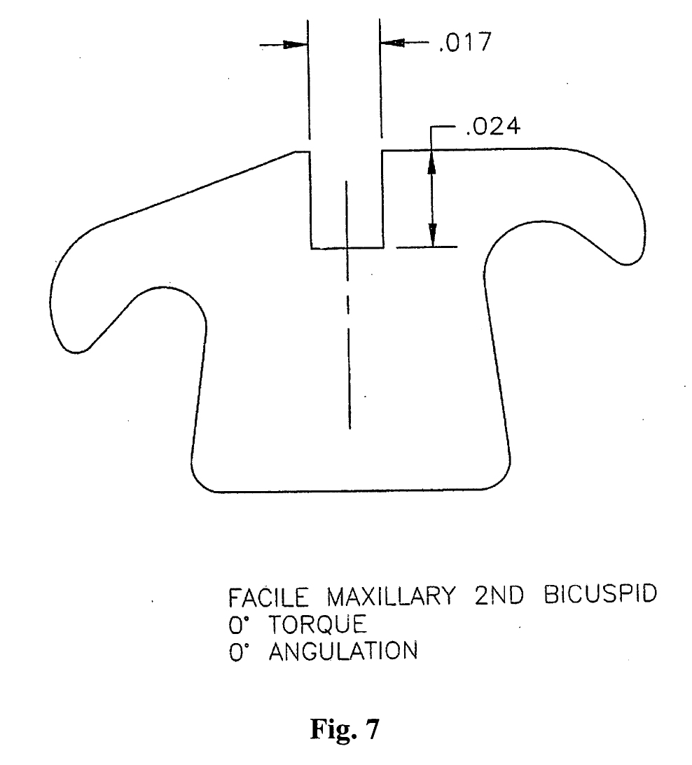

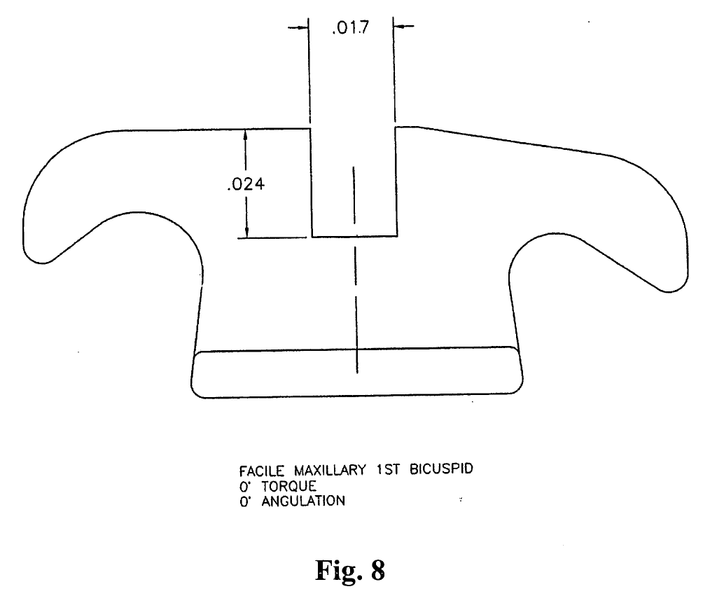

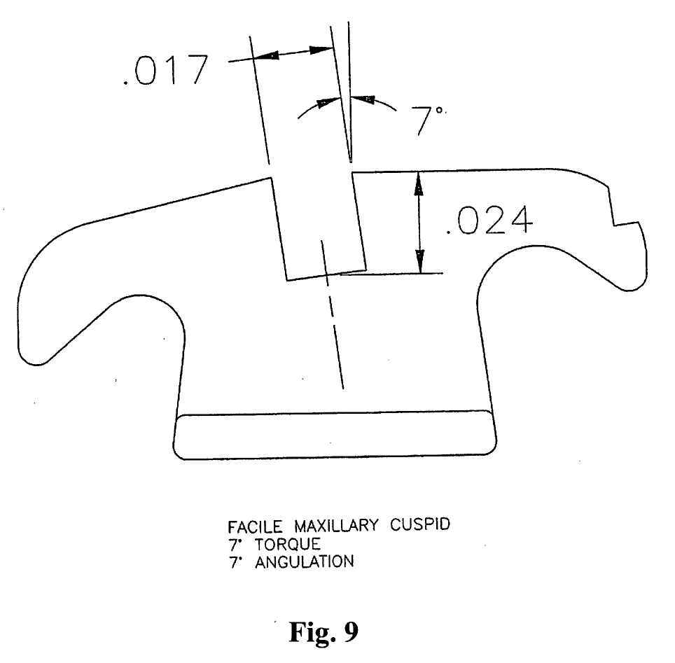

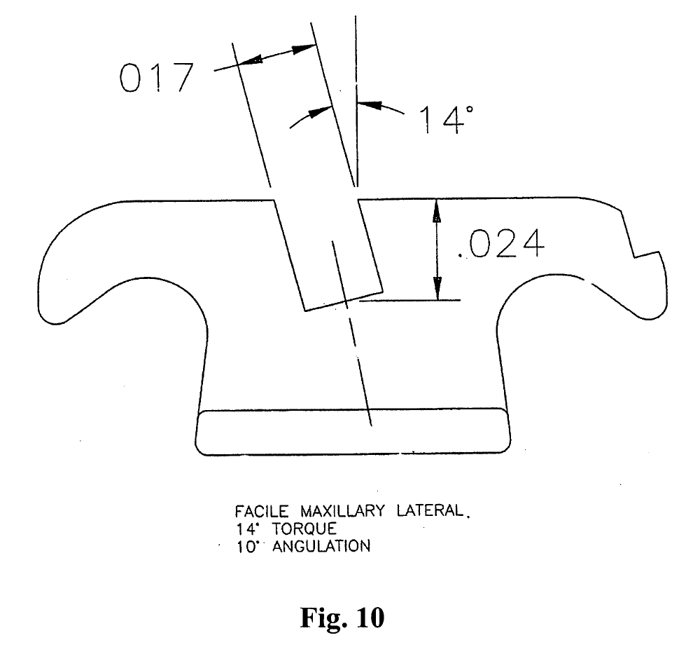

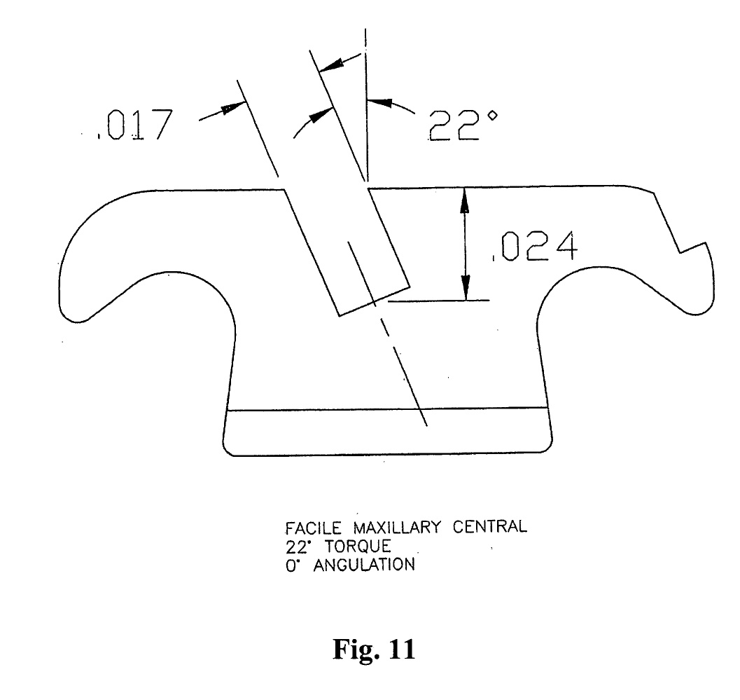

### DETAILED DESCRIPTION OF THE INVENTION

Various embodiments of the orthodontic bracket of the present invention shown in FIGS. 17 through 28, wherein each bracket embodiment includes a slot of approximately 0.017 inches in width and approximately 0.024 inches in depth. One skilled in the art will readily have the ability to make and use the brackets of the present invention.

Additionally, note that bracket embodiments (and in particular embodiments having a slot width of 0.017″) according to the present invention can also be used for attaching a 0.012″×0.017″ wire, a 0.016″×0.016″ wire, and a 0.015″×0.015″ wire. Such smaller wires can be especially useful in delivering lower orthodontic forces and aid in control of finishing of an orthodontic procedure. Note that such small wires can not be used with brackets having larger sized slots than the upper limit of the slot size for the present invention during finishing of an orthodontic procedure due to the problems (a) and (b) recited in the Objects Of The Invention section hereinabove.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. An orthodontic bracket comprising a wire slot having a width of less than 0.0175 inches.

2. The orthodontic bracket of claim 1, wherein said slot width is greater than 0.0165 inches.

3. The orthodontic bracket of claim 1, wherein said slot has a depth in the range of approximately 0.026 inches to 0.022 inches.

4. The orthodontic bracket of claim 3, wherein said slot has a depth of approximately 0.024 inches.

5. The orthodontic bracket of claim 1, wherein said bracket is effective for securing an orthodontic wire in said slot for a finishing orthodontic procedure, wherein said slot effectively secures a cross section of the wire, said cross section being in a range of 0.012 to 0.015 inches by 0.015 to 0.017 inches.
